(19) United States
(12) Patent Application Publication
(10) Pub. No.: US 2014/0143173 A1
(43) Pub. Date: May 22, 2014

(54) SYSTEMS AND METHODS FOR USING A REVERSE MORTGAGE AS A PORTFOLIO SUPPLEMENT

(71) Applicant: GERALD COCHRANE WAGNER, Alameda, CA (US)

(72) Inventor: GERALD COCHRANE WAGNER, Alameda, CA (US)

(21) Appl. No.: 13/830,725

(22) Filed: Mar. 14, 2013

Related U.S. Application Data
(60) Provisional application No. 61/727,623, filed on Nov. 16, 2012.

(51) Int. Cl. G06Q 30/06

(52) U.S. Cl. CPC G06Q 30/06
USPC 705/36 R

(57) ABSTRACT

Systems and methods are described for providing information to retirees wishing to supplement a retirement investment portfolio by judicious use of funds from one of several available reverse mortgage programs. System inputs can include data about the retiree(s), the investment portfolio, a primary residence, a desired amount of funds to be drawn on a monthly, yearly, or other regular basis. Based at least in part on the accepted data, various simulations can be run which show the likelihood of the portfolio lasting and providing the desired funds across the length of the retirement planning horizon. Simulations can include, scenarios in which (a) no reverse mortgage funds are used, (b) reverse mortgage funds are used until they are exhausted before beginning to draw funds from the investment portfolio, and/or (c) scenarios in which regularly scheduled reverse mortgage funds are used to supplement (and thereby reduce) portfolio withdrawals.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### LIMITED COPYRIGHT AUTHORIZATION

A portion of the disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### BACKGROUND OF THE DISCLOSURE

1. Field of the Disclosure

Among other things, this disclosure describes systems and methods for identifying a strategy and strategically using funds from a reverse mortgage in order to prolong and preserve a retirement investment portfolio.

2. Description of the Related Art

People facing retirement who have managed to acquire a financial portfolio (typically a mix of equities and bonds) and a home often work with a professional financial planner to determine a retirement funding strategy that will allow them access to continuous regular amounts of money from their assets for spending throughout the years of their retirement. The probability that, by following any one given retirement funding strategy of several available retirement funding strategies, their money will last long enough to provide their desired amount of funds for spending throughout the years of their retirement is frequently referred to as the likelihood of “spending success” of the given funding strategy.

One commonly-held principle long used by financial planners has been the notion that if a couple or individual, having a portfolio of retirement savings and embarking on retirement, withdraws 4.0% of their portfolio for spending in their first year of retirement, and equal dollar amounts in each subsequent year (adding only a 2.5% increase each year to account for inflation), then, if their portfolio is invested 50% or more in equities, their money could have a 90% chance of lasting for 30 years.

In planning for their retirement spending, individuals consider all sources of future income including pension plans, Social Security, and planned withdrawals from savings. Social Security and some pension plans automatically adjust their disbursements to keep up with the Consumer Price Index (CPI). Planned withdrawals from retirement savings could also be scheduled to keep up with the CPI. Another source of retirement income could be using the equity in their home.

However, many retirees will live longer than 30 years, which, according to the conventional financial wisdom, dictates that they must spend even less than the initial 4.0% amount of their portfolio per year if they want their money to last their entire lifetime. At the same time, many retirees would actually prefer to have available a larger amount of their money to spend during their retirement, while being able to maintain a desired level of risk management and financial predictability.

Reverse mortgages are nonrecourse loans that allow individuals to tap their home equity. Monies received are tax-free since they are loan advances. And, unlike home equity lines of credit (HELOC), reverse mortgages require no payments to the lender before the homeowner leaves the home; additionally, unlike the HELOC, reverse mortgages cannot be unilaterally frozen or canceled by the lender.

### BRIEF DESCRIPTION OF THE DRAWINGS

Throughout the drawings, reference numbers are re-used to indicate correspondence between referenced elements. Furthermore, the first digit of each reference number indicates the figure in which that reference number was first introduced. The drawings are provided to illustrate embodiments of the inventive subject matter described here and not to limit the scope thereof.

FIG. 1 is an overview flowchart that illustrates one embodiment of a computer system for determining and implementing a strategy for using a reverse mortgage as a portfolio supplement.

FIG. 2 is a flowchart that illustrates an alternate embodiment of a computer system for determining and implementing a strategy for using a reverse mortgage as a portfolio supplement.

FIG. 3 is a flowchart that illustrates the workings of one embodiment of a Mortality Engine.

FIG. 4 is a flowchart that illustrates an alternate embodiment of a computer system for determining and implementing a strategy for using a reverse mortgage as a portfolio supplement.

FIG. 5 has been split into two sections, FIG. 5A and FIG. 5B, which together extend across two drawing sheets. For purposes of this specification, FIG. 5A and FIG. 5B will be treated as one figure, FIG. 5. FIG. 5 depicts a sample embodiment of Monte Carlo simulation results that can be generated and presented to a user. The data results provide a pictorial comparison of various retirement funding strategies.

FIG. 6 is an illustrative embodiment of additional simulation results that may be generated and presented to a user to provide a comparison of various retirement funding strategies.

FIG. 7 is a block diagram that depicts one embodiment of a computer system for determining and implementing a strategy for using a reverse mortgage as a portfolio supplement.

### DETAILED DESCRIPTION

Various embodiments of systems, methods, processes, and data structures will now be described with reference to the drawings. Variations to the systems, methods, processes, and data structures, which represent other embodiments, will also be described. Certain aspects, advantages, and novel features of the systems, methods, processes, and data structures are described herein. It is to be understood that not necessarily all such advantages may be achieved in accordance with any particular embodiment. Accordingly, the systems, methods, processes, and/or data structures may be embodied or carried out in a manner that achieves one advantage or group of advantages as taught herein without necessarily achieving other advantages as may be taught or suggested herein.

### Introduction

Generally described, aspects of the present disclosure relate to systems and methods for providing information to an individual wishing to supplement his or her retirement investment portfolio by judicious use of funds from one of several available reverse mortgage plans. Various embodiments of the systems and methods provide for the acceptance of data about the individual, about the individual's investment portfolio, and about a primary residence belonging to the individual. Additional input regarding the individual's desired amount of funds to be drawn on a monthly, yearly, or other scheduled basis can also be accepted. Based at least in part on the accepted data, various simulations can be run which show the likelihood of the individual's portfolio lasting and providing the desired funds across the length of the individual's retirement planning horizon. Simulations can include, among others, scenarios in which (a) no reverse mortgage funds are used, (b) reverse mortgage funds are used until they are exhausted before beginning to draw funds from the individual's investment portfolio, and/or (c) scenarios in which regularly scheduled reverse mortgage funds are used to supplement (and thereby reduce) portfolio withdrawals. Furthermore, the simulations may include scenarios which show the relative advantages and detriments of different types of available reverse mortgage plans and funding strategies.

Besides supplementing withdrawals from a portfolio, having a reverse mortgage allows one to safely increase their portfolio expected risk and return. To a degree, higher expected returns give higher chances of spending success. The reverse mortgage mitigates portfolio risk, especially if there are several years early in retirement that experience poor portfolio returns. Besides materially increasing spending success in retirement, the use of a reverse mortgage supplement can increase the retiree's net worth. This is especially true when the value of a retiree's home forms a significant portion of the retirees overall assets, and a reverse mortgage provides a means for borrowing money at a lesser rate than the portfolio portion of the assets can grow. Although reverse mortgages have traditionally been thought of as strategy of “last resort” for retirees who are “house-rich and cash-poor,” the systems and methods described herein can provide an unexpected and advantageous benefit to retirees with material assets besides just their home.

### Terminology

Although the description provided herein refers to users, individuals, consumers, clients, or customers, the terms “user,” “individual,” “consumer,” “customer,” “client”, “people” and “persons” should be interpreted to include groups of individuals, such as, for example, married couples or domestic partners, and other entities.

We assume the system can be used by a financial advisor or mortgage lender on behalf of a client, and, in other embodiments, it can additionally or alternatively be a stand-alone self-help system for use by an individual or couple or other joint home owners. The system is designed to be easily understood by financial advisors, financial planners, and lenders, and to be easily explainable to their clients.

In general, we use the terms spending horizon and planning horizon interchangeably. It is the number of years in the future that the retiree intends for their portfolio to provide retirement income.

We use the terms advances, payments, disbursements, and withdrawals somewhat interchangeably. It is important to remember that in a reverse mortgage, the payments are to the borrower, so we often use the term advances for the monies taken from a reverse mortgage. The term disbursements, as used herein, generally refers to withdrawals from a portfolio.

We use the term portfolio to include all retirement savings such as a client's 401(k), IRA, mutual funds, and other portfolios of individual securities. The financial advisor, planner or retiree could consider these as an aggregate pool of savings and should have an understanding of the pool's overall expected risks, expected returns, and ability to provide retirement income. In contrast to investments, reverse mortgages are very predictable especially if one of several forms of scheduled monthly advances is chosen.

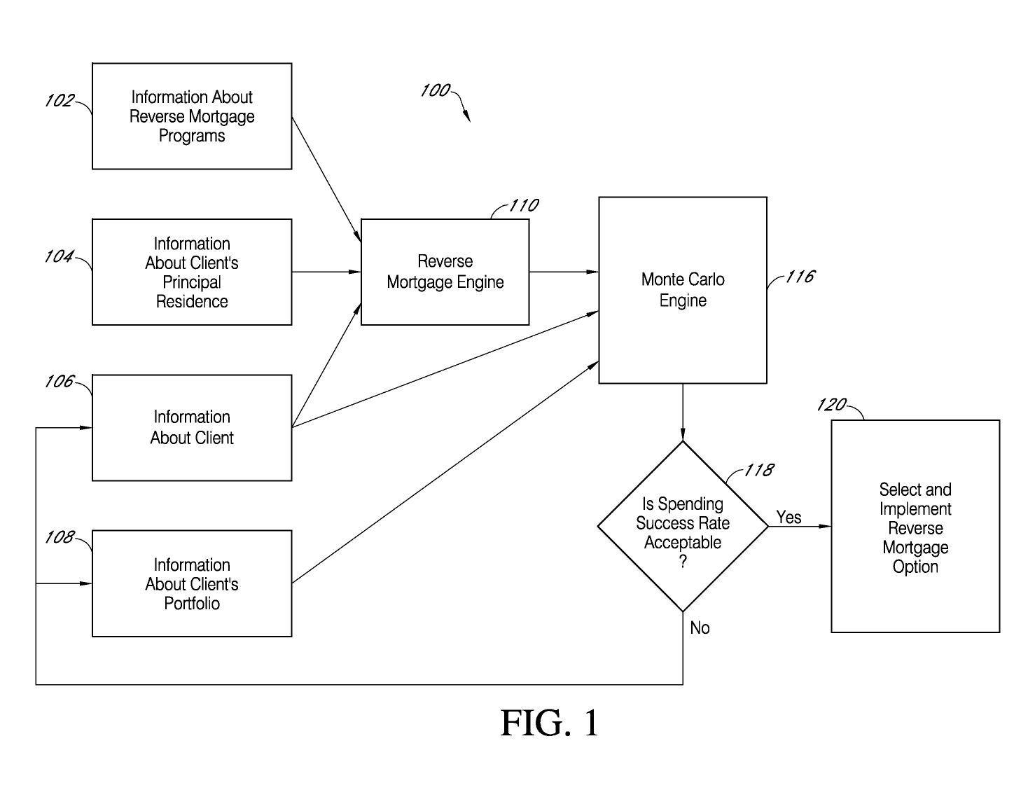

FIG. 1 is an overview flowchart that illustrates one embodiment of a computer-assisted system 100 for determining and implementing a retirement funding strategy using a reverse mortgage as a portfolio supplement. In one embodiment, the system as described is envisioned as being used on behalf of a client, who is an individual or a married couple or other domestic partnership, in order to assist the client in selecting and implementing a strategy for retirement funding which the client believes will lead to an acceptable likelihood of “spending success”. In other embodiments, the system may be used on behalf of other entities as an educational or other beneficial tool.

### System Inputs

In the embodiment shown in FIG. 1, information regarding reverse mortgage programs 102 can be gathered. Information regarding reverse mortgage programs 102 may comprise, among other things, information about government and/or private reverse mortgage programs and products, information about rules and rates that apply to reverse mortgage programs and products, information about fees and costs associated with reverse mortgage programs and products, and information about laws and taxes that apply to reverse mortgage programs and products. Other information regarding reverse mortgage programs may additionally and/or alternatively be included.

As further shown in FIG. 1, information about a client's home 104 can be gathered. Information regarding a client's home 104 may comprise, among other things, estimated home value, estimated annual future appreciation, standard deviation of future appreciated property value, any current liens and/off payoffs due against the home, and/or estimated future costs associated with selling the client's home. Other information regarding the client's home may additionally and/or alternatively be included.

Additionally, as shown in FIG. 1, information about the client 106 can be gathered. As indicated above, in various embodiments, the client may be an individual or a married couple or other domestic partnership. The information about the client 106 may comprise, among other things, information about birth date(s), gender(s), and state(s) of health. The information about the client 106 can further include information about actual and/or estimated past and future earnings, estimated Social Security benefits, other potential retirement income streams, current and/or expected future expenses, and current and/or expected future marginal tax rates, including tax rates on ordinary income and tax rates on capital gains.

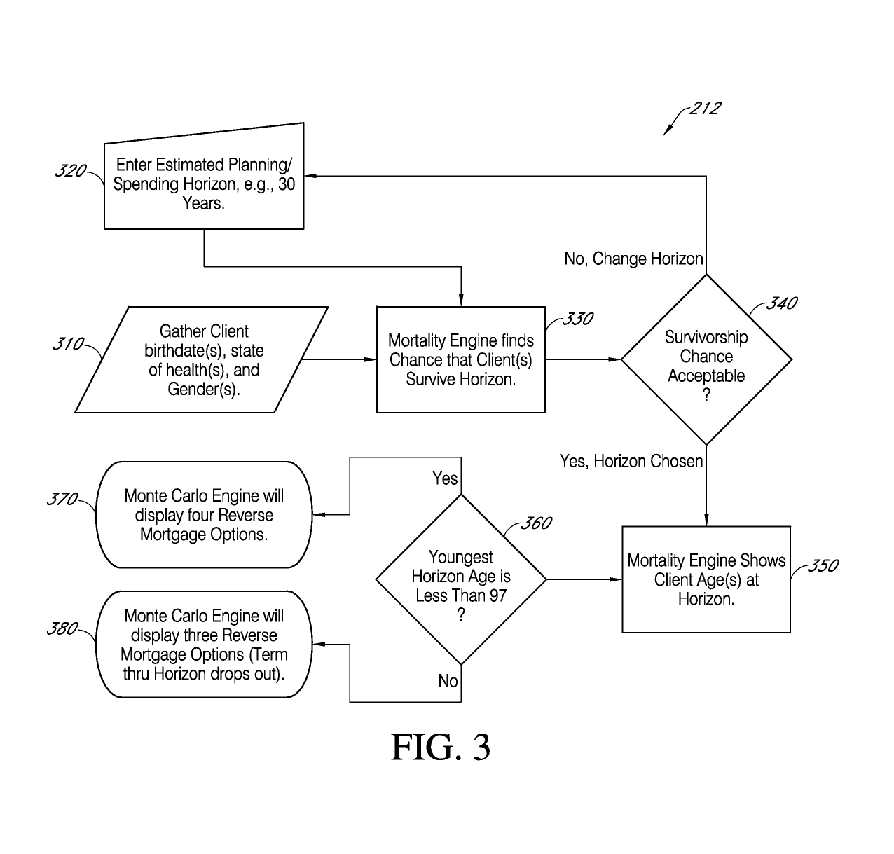

In various embodiments, the information about the client 106 can include an indication of a desired planning horizon, also known as a desired spending horizon, which is a number of years for which the client wishes to plan future retirement spending. Frequently, clients wish to plan future retirement spending for at least as long, if not longer, than they expect to live. A common planning horizon currently used by financial planners is thirty years. If a client is sixty-three years old, and the desired planning horizon is thirty years, then future disbursements and assets accounted for in the spending strategy will cover the period approximately until the client turns ninety-three years old. As will be described in greater detail with respect to the mortality engine of FIG. 3, it may frequently be desirable to use a different spending horizon and, in particular, a longer spending horizon.

In various embodiments of the system 100, information about the desired planning horizon can be a decision variable that is adjusted by the client, or financial advisor, or other user of the system, during different iterations of the system 100, in order determine and understand potential benefits and risks associated with various spending strategies over a variety of spending horizons.

As also shown in FIG. 1, information about the client's portfolio 108 can be gathered. For example, information about one or more measures of current value, current cost basis, interest and dividend yield, estimated annual mean total return from the portfolio investment, and/or standard deviation of future returns can be gathered.

For clients wishing to determine a spending strategy for their retirement years that will provide them with a regular fixed income (or a “fixed” income that accommodates inflation), a common method of designating that fixed income amount has been to describe it as a percentage of their total portfolio value at the start their retirement, or as a dollar amount equivalent to that percentage. Accordingly, in one or more embodiments, the information about client's portfolio 108 can include information about the client's desired first year's withdrawal, which can be expressed as a percentage of the initial portfolio value. In various embodiments of the system 100, information about the client's desired first year's withdrawal can be a decision variable that is adjusted by the client, or financial advisor, or other user of the system, during different iterations of the system 100, in order allow the system to demonstrate benefits and risks associated with various spending strategies based on a variety of first year's withdrawal amounts.

In various embodiments, the information about the portfolio 108 can further include information about estimated future inflation rates, as measured by the Consumer Price Index (CPI) or other descriptor, and/or an expected standard deviation of the future inflation rate.

### Reverse Mortgage Engine

As shown in FIG. 1, some or all of the information about reverse mortgage programs 102, the information about the client's home 104, and the information about the client 106, can be transmitted to the reverse mortgage engine 110, which can then generate reverse mortgage information about one or more available reverse mortgage programs that is personalized to the client. Advances from a reverse mortgage can include upfront cash, scheduled monthly advances, future withdrawals from a line of credit, or any combination of the three. As described more fully below, scheduled monthly advances can take two or more forms. One form is called a home tenure plan which advances monthly funds to the borrower so long as their home is their principal residence. Another form is called a term plan which advances monthly funds to borrower over a preset number of months. When that term is reached, monthly advances stop, but the reverse mortgage is not due until the borrower's home is no longer their principal residence.

Furthermore, in various embodiments the reverse mortgage engine 110 can advantageously generate personalized information about comparisons between scheduled reverse mortgage advances that can be available to the client and equivalent advances available to the client from taxable sources, such as from their retirement savings portfolio. An aspect of some embodiments of the system 100 is a recognition that disbursements from a reverse mortgage are considered by tax law as being loan advances, and, as such, are not taxable, while disbursements from a retirement savings portfolio, for example, are taxable. To the extent the disbursements include interest and dividends they are taxed as ordinary income. Realize capital gains are generally taxed at a lower rate than ordinary income. Retirement spending strategies that do not include this recognition can treat a $1,000 disbursement from a reverse mortgage as being equivalent to a $1,000 disbursement from a retirement savings portfolio. In fact, in a high-tax state such as California, the $1,000 non-taxable reverse mortgage disbursement can be equivalent in spending power to $1,549 of interest and dividends, or, if the portfolio's tax basis is 50% of its value, $1,249 of principal withdrawal. Furthermore, this recognition can significantly impact the calculations of the various retirement spending strategies. Knowledgeable and accurate application of this understanding can actually afford the retired client an increased monthly amount available for spending without diminishing the client's chance of spending success as will described in great detail below.

### Monte Carlo Engine

As further depicted in FIG. 1, data from the Reverse Mortgage Engine 110, data from the information about the client 106, and data from the information about the client portfolio 108 can be obtained by the Monte Carlo Engine 116. In general, Monte Carlo simulations are a problem-solving technique use to approximate the probability of certain outcomes by running multiple computational trial runs, called simulations, using random variables. Although each individual simulation might produce a very different result from the next, by running hundreds or thousands of simulations and analyzing the results, patterns and useful probabilities can be discerned. The Monte Carlo Engine 116 can compare two or more retirement funding strategies for display to the client, including, for example, display of a predicted likelihood of “spending success” for each of the two or more retirement funding strategies over a selected planning horizon. In various embodiments, the display to the client may be via digital image, such as presented on a computer, personal digital device, telephone, handheld device, or other electronic screen, sent via email or other electronic messaging system, printed out onto paper for review, and/or any of a variety of other known and/or convenient display methods. By running thousands of Monte Carlo simulations a clear picture can be found about spending success over the planning horizon and the likelihood of various future values such as portfolio balances, home values, and reverse mortgage balances. Assuming that enough simulations are run each time to generate a statistically reliable result, then if the simulations are run a second time with the same inputs, the results can be the same or very similar. In some embodiments of the Monte Carlo Engine 116, many of the variables are stochastic, that is, they are random, but they have an expected annual mean and standard deviation. These stochastic variables include, but are not limited to, annual portfolio returns, annual inflation (CPI), annual home appreciation, and the monthly interest rate on the reverse mortgage (which can be based on one or more publicly available LIBOR rates).

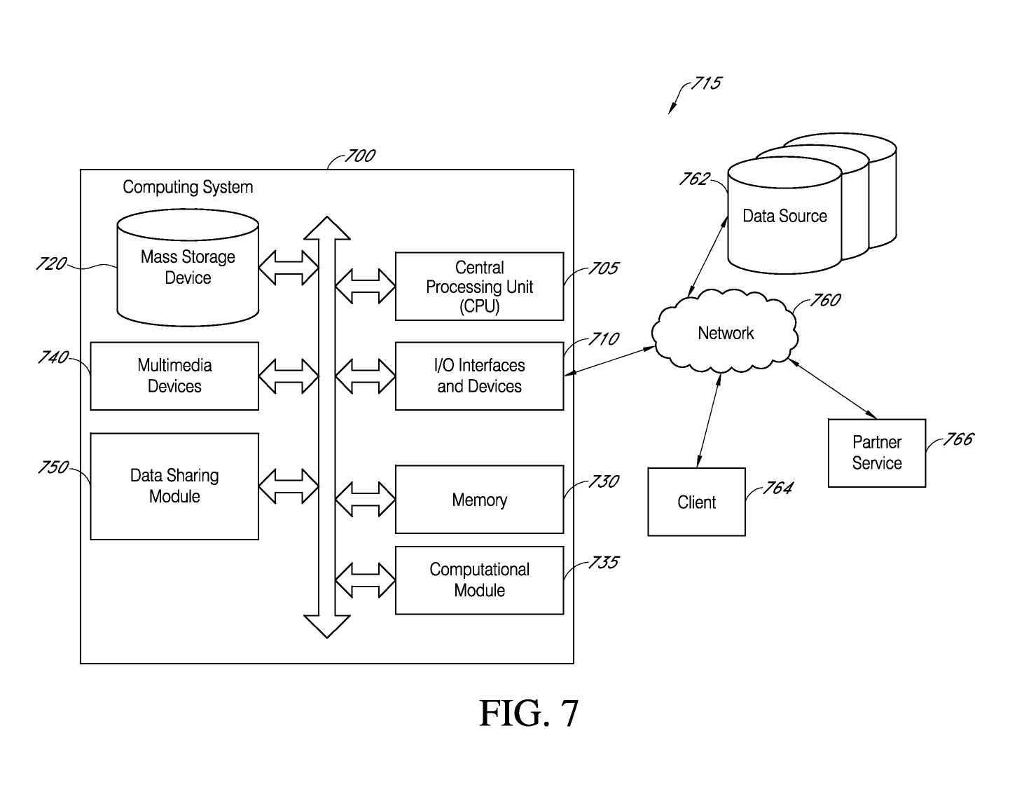

In some embodiments, one or more of the estimated annual means and/or the standard deviation values associated with the annual portfolio returns, annual inflation (CPI), annual home appreciation, and/or the monthly interest rate on the reverse mortgage are values that are stored in memory within the system, as is described further with reference to FIG. 7 below. In some embodiments, individuals users of the system 100, such as financial planners and/or lenders, can choose to input one or more of these values based on their own professional expertise and understanding. In some embodiments, one or more of these values may be updated regularly or in response to changes in market conditions. In some embodiments, other known and/or convenient methods of obtaining the estimated annual means and/or the standard deviation values for the stochastic variables for the Monte Carlo simulations can be used.

Running the Monte Carlo simulations using inputs that are drawn from the information about the client's own personal situation allows the system 100 to provide statistically sound, predictive, and personalized information for clients seeking to take steps to ensure a level of financial stability and security for themselves in the face of an always-uncertain future.

### Selection and Implementation of a Reverse Mortgage Option

Once the client has reviewed the displayed data, in some embodiments, such as is shown in FIG. 1, the client can decide whether any one or more of the retirement funding strategies compared by the Monte Carlo Engine 116 is associated with a “spending success” rate that is acceptable to the client 118. If the client decides that one of the retirement funding strategies has an acceptable likelihood of “spending success,” one or more options may be presented to the client for selecting and implementing a retirement funding strategy 120, such as, for example, a retirement funding strategy that includes a reverse mortgage.

Alternatively, if upon reviewing the displayed data from the Monte Carlo Engine 116, the client decides 118 that none of the displayed likelihoods of “spending success” for the one or more strategies of retirement funding are acceptable, the client has the option to revise one or more of the input variables, such as, for example the desired level of retirement spending, which was input as part of the portfolio information 108. The computer-assisted system 100 for determining and implementing a retirement funding strategy using a reverse mortgage as a portfolio supplement can then re-run the Monte Carlo Engine 116 using the newly revised one or more input variables to see if the updated results displayed include a retirement funding strategy with an acceptable likelihood of “spending success” across the client's chosen planning horizon.

### An Alternate Embodiment

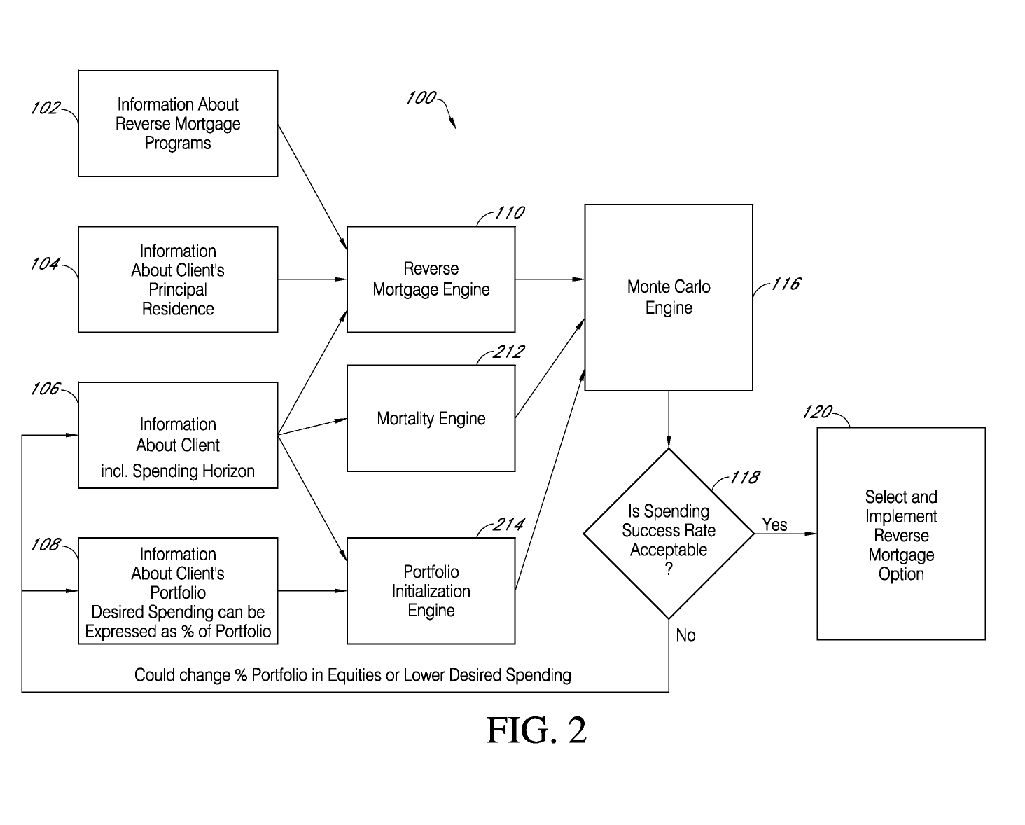

FIG. 2 depicts an overview flowchart that illustrates an alternate embodiment of the computer-assisted system 100 for determining and implementing a retirement funding strategy using a reverse mortgage as a portfolio supplement.

As was depicted in the overview flowchart of FIG. 1, the system 100 can obtain information about reverse mortgages 102. In various embodiments, the information about reverse mortgages 102 can additionally or alternatively (with respect to the description of the reverse mortgage information 102 provided with reference to FIG. 1) include details of available reverse mortgage programs, such as programs which provide regularly scheduled disbursements of funds from a reverse mortgage to the homeowner for as long as the homeowner continues to live in the home. Such regularly scheduled disbursements can be known as “scheduled advances” of a reverse mortgage. At least one first type of scheduled-advance reverse mortgage program can be known as a Home Tenure plan, which pays regular periodic (such as, for example, weekly, monthly, or yearly) scheduled advances to the homeowner(s) for as long as at least one homeowner continues to live in the home. For example, at least one type of currently available Home Tenure reverse mortgage program calculates monthly disbursements to the homeowner based on a hypothetical tenure of the homeowner in the home until the age of one hundred. Nonetheless, monthly disbursements to the homeowner continue for as long as the homeowner lives in the home, even if he or she stays in the home beyond the age of one hundred.

At least one second type of scheduled-advance reverse mortgage plan can be known as a Term Scheduled Advances plan, which pays regular periodic (such as, for example, weekly, monthly, or yearly) scheduled advances to the homeowner(s) for only an agreed-upon length of time and only as long as at least one homeowner continues to live in the home. Term Scheduled Advances plans are thus potentially more limited in duration than the Home Tenure Scheduled Advances plans and they accordingly can pay out a higher disbursement amount than the Home Tenure Scheduled Advances plan, when other variables are held constant.

In various embodiments of the systems and methods described herein, the Reverse Mortgage Engine 110 and/or the Monte Carlo Engine 116 are configured to include in their calculations program-specific information about the various upfront and ongoing costs, and various disbursement levels, and other financial difference between the various reverse mortgage programs as part of the comparison scenarios that they provide for display to the client.

Various other types of reverse mortgage programs, available currently and/or in the future, maybe be used with the systems and methods described herein. For example, some reverse mortgage programs can provide to the homeowner a Line of Credit that is based on a reverse mortgage instead of the types of scheduled disbursements described above. Each reverse mortgage has a “loan capacity” that defines an amount of money available to the homeowner based on the reverse mortgage. Additionally, any unused capacity of a reverse mortgage grows at a predefined rate. Advantageously, “scheduled advances” are calculated using a rate that is most often significantly higher than the rate at which the unused capacity of Line of Credit reverse mortgage programs grows. For example, in mid-March of 2013, Term Scheduled Advances reverse mortgages and Home Tenure Scheduled Advances reverse mortgages plans were calculated using an annual rate of 4.28%, while the annual growth rate of the unused capacity of Line of Credit reverse mortgages was only 2.45%. These rates indicate that a borrower could take a fixed dollar amount over 135 months using a Term Scheduled Advance plan, while the reverse mortgage Line of Credit would be exhausted in one hundred and twenty-seven months (ten years and seven months) when withdrawing the same amount of money each month. Over time, such differences in the ways reverse mortgages are constructed can make a significant difference in the amount of funds available to a retiree. In various embodiments of the systems and methods described herein, the Reverse Mortgage Engine 110 and/or the Monte Carlo Engine 116 are configured to include calculations of the growth rates of unused reverse mortgage capacity as part of the comparison scenarios that they provide for display to the client.

As was described with reference to the embodiment of the system 100 depicted in FIG. 1, the embodiment depicted in FIG. 2 also provides for obtaining information about the client's home 104 and information about the client 106.

As was depicted in the overview flowchart of FIG. 1, the system 100 can obtain information about the client's retirement investment portfolio 108. In various embodiments, the information about the client's investment portfolio 108 can additionally or alternatively (with respect to the description of the investment portfolio information 108 provided with reference to FIG. 1) include information about the client's portfolio allocation as a ratio of stocks and other equities with respect to bonds and other fixed yield assets. Various such allocation ratios can be associated with different long-term levels of portfolio risk, as well as with different long-term levels of potential gain.

In various embodiments of the systems and methods described herein, the Reverse Mortgage Engine 110 and/or the Monte Carlo Engine 116 are configured to include calculations that account for appropriate levels of portfolio risk and potential portfolio gain over the planning horizon, as personalized for the client's portfolio asset allocation ratio, and as included in the comparison scenarios that they provide for display to the client.

Furthermore, in various embodiments of the system 100, information about the portfolio asset allocation ratio can be a decision variable that is adjusted by the client, or financial advisor, or other user of the system, during different iterations of the system 100, in order determine and understand potential benefits and risks associated with various spending strategies over a variety of spending horizons. For example, a client who finds an initial set of “spending success” rates displayed by the Monte Carlo Engine 116 to be unacceptable, can choose to revise the portfolio asset allocation ratio and to see if the system 100 provides “spending success” results based on the revised ratio that are more acceptable to the client. If so, the client can choose to actually change the asset allocation of their retirement investment portfolio.

As further shown in FIG. 2, in some embodiments, the system 100 can include a Mortality Engine 212 that obtains some or all of the information about the client 106 and that provides information to the Monte Carlo Engine 116. The Mortality Engine 212 is described in greater detail with reference to FIG. 3 to follow.

The embodiment of the system 100 depicted in FIG. 2, can also include a Portfolio Initialization Engine 214 that can use information about the client 106 and/or information about the portfolio 108 and that provides information to the Monte Carlo Engine 116. The Portfolio Initialization Engine 214 can calculate annual advances from the portfolio, expected tax liability from interest, dividends and capital gains, and the effects of the expected future inflation rate (also known as the Consumer Price Index CPI).

In some embodiments of the system 100, a Social Security Engine (not shown) obtains information about the client(s). The Social Security Engine can calculate and can provide to the Monte Carlo Engine 116 the following, for generating the future spending strategy scenarios for display to the client: the effects of taking Social Security benefits beginning at age sixty-two, the effects of taking Social Security benefits beginning at normal retirement age, and the effects of taking Social Security benefits beginning at age seventy.

The Reverse Mortgage Engine 110 can calculate and can provide to the Monte Carlo Engine 116 a wide variety of possible monthly dollar advances from a Home Tenure Advance, Term Plan Advance, and Line of Credit combinations including, but not limited to, the dollar amount of Home Tenure Advances, the dollar amount of Term Plan Advances over the planning horizon, the dollar amount of Term Plan Advances over any term shorter than the planning horizon, and how many months can Term Plan Advances equal to the desired first-year portfolio withdrawal be advanced.

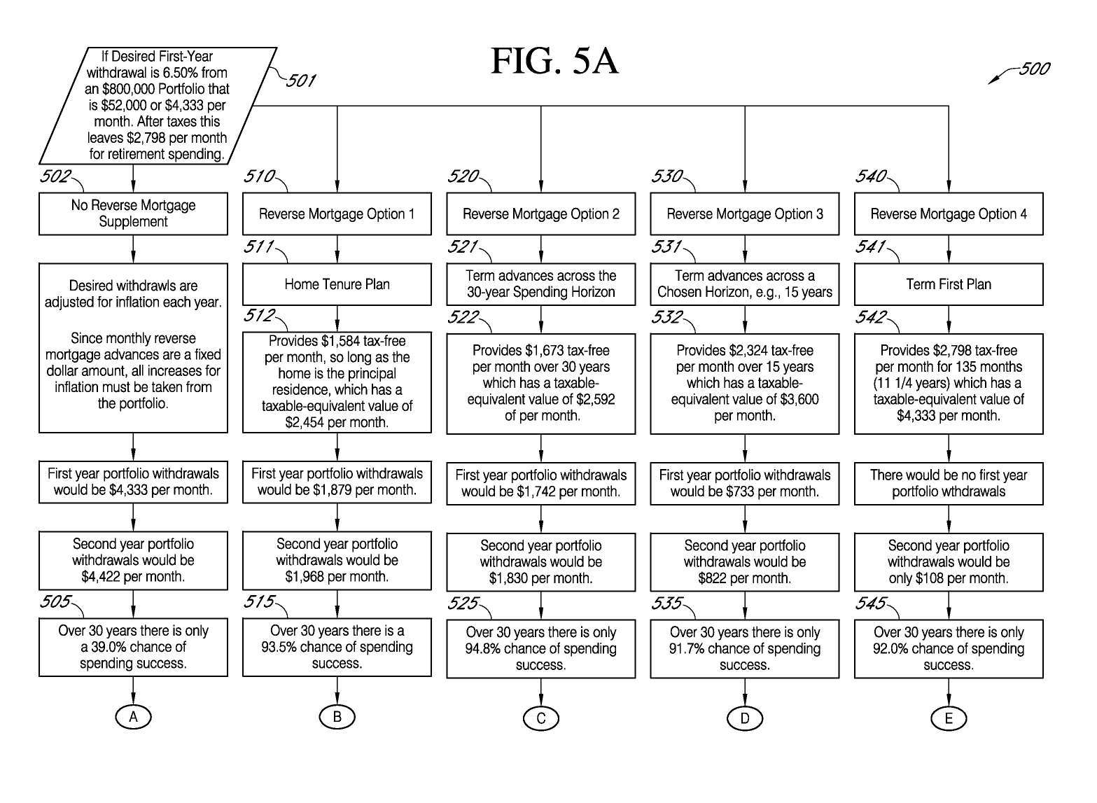

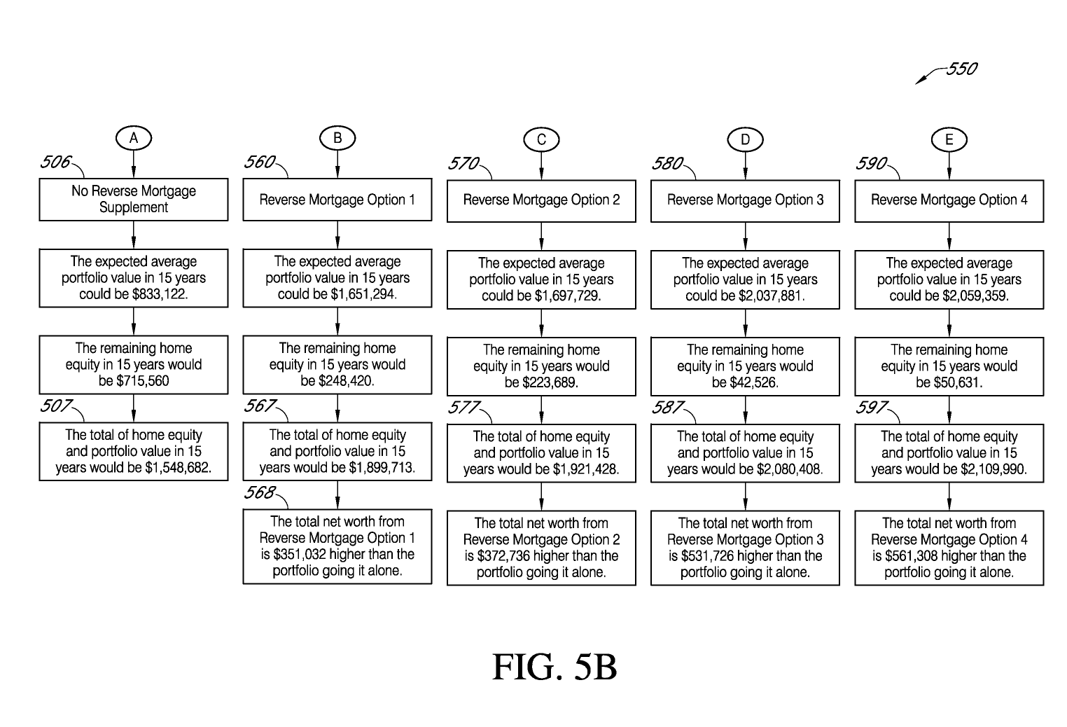

The Monte Carlo Engine 116 can generate and display data for a comparison of different spending strategy scenarios. As one example, which is depicted in greater detail in FIGS. 5A and 5B, the Monte Carlo Engine 116 can generate and display data scenarios regarding: (1) a retirement funding strategy that draws funds solely from the Portfolio, and does not include supplementation with a reverse mortgage, (2) a retirement funding strategy that makes use of additional funds received as scheduled advances from a Home Tenure Reverse Mortgage plan, (3) a retirement funding strategy that makes use of additional funds received as scheduled advances from a Term Reverse Mortgage plan over the planning horizon, (4) a retirement funding strategy that makes use of additional funds received as scheduled advances from a Term Reverse Mortgage plan over any number of months short of the planning horizon, and (5) a retirement funding strategy that draws advances solely (except for cost-of-living increases) from a Term Reverse Mortgage plan, until those funds are exhausted, and only then begins drawing funds from the retirement portfolio.

The Monte Carlo Engine 116 can additionally estimate the chances of “spending success” at the planning horizon for each of the funding strategy scenarios. In some embodiments, the Monte Carlo Engine 116 can further provide estimated results for a variety of financial markers at the end of one or more test periods that are shorter than the entire planning horizon. Although it is generally important to retirees to select a retirement funding strategy with a high “spending success” for the length of the planning horizon (See the description of the Mortality Engine in FIG. 3), it is frequently more immediately understandable and reassuring to see an accounting of the financial markers after a shorter period of time, such as after fifteen years. For example, in various embodiments, the Monte Carol Engine 116 can calculate and display information about estimated results at the end of a given test period for review by the client about one or more of the following: estimated remaining home equity, average portfolio balance over the test period, estimated portfolio balance at the end of the test period, likelihood that the increase in the portfolio balance supplied by the reverse mortgage supplement would be sufficient to pay off the reverse mortgage liability, client's net worth if they used the nonrecourse feature of the reverse mortgage, and clients net worth if they chose to pay off the reverse mortgage in full. Additionally, the Monte Carlo Engine 116 can test the “spending success” results using various spending draw rates (based on initial portfolio value), such as 4%, 5%, 6% and/or any other draw rates of interest to the client. Based on the results generated by the Monte Carlo Engine 116, the client and/or financial planner or other financial professional can select a preferred plan, which can have a reverse mortgage component, having an acceptable “spending success” rate from amongst the displayed scenarios.

If no scenario having an acceptable “spending success” rate has been displayed, the client may wish to adjust one or more input variables, such as, for example, spending draw rate and/or percentage of portfolio in equities, and have the system 100 re-run the Monte Carlo simulations based on the new variables.

### The Mortality Engine

FIG. 3 depicts a flow chart that describes the working of a Mortality Engine 212 tool which can provide various types of mortality-related information relevant to the generation of a retirement spending strategy. For example, most people and even many financial planners cannot tell a client how many years in the future is the point where there is a 10% or less chance that client and/or his or her spouse will be alive. Embodiments of the systems and methods described here which include the Mortality Engine tool 212 help inform and motivate clients to be sure that they are planning for a sufficiently long retirement.

As depicted in FIG. 3, the Mortality Engine begins at 310 where information about the client birth date(s), state(s) of health, and gender(s) is obtained. At 320, an estimated planning/spending horizon, such as thirty years, is selected and entered. At 330, the Mortality Engine uses actuarial and other data to calculate a likelihood that the client and/or spouse will survive beyond the planning horizon. At 340, the client and/or other user decides whether the calculated likelihood of survivorship beyond when retirement funds are predicted to last is acceptable.

If the calculated likelihood of survivorship is not acceptable, the client and/or other user can revise the planning/spending horizon at 320, and the new planning/spending horizon can be used at 330 by the Mortality Engine to recalculate the likelihood of survivorship beyond the exhaustion of the retirement funds. If the calculated likelihood of survivorship is acceptable, at 350 the Mortality Engine shows the client age(s) at the spending horizon.

In some embodiments of the Mortality Engine 212, the process continues here to 360, where a determination is made whether the youngest client age at the spending horizon is less than ninety-seven. If the answer is yes, then at 370, the Monte Carlo Engine 116 can calculate and display results for several reverse mortgage options, included a “Term through Horizon” Option. If the answer is no, then at 380, the Monte Carlo Engine 116 can calculate and display results for several reverse mortgage options, but not including a “Term through Horizon” Option. This is because in the most popular reverse mortgage product, the monthly advance from a Home Tenure Scheduled Advances plan is calculated assuming the borrower lives to age one hundred. However Home Tenure Scheduled Advances continue so long as the borrower's home is their principal residence even if they live to be 110 years old. However, if a borrower is now sixty-seven years old and has a thirty-year planning horizon, a “Term through Horizon” Option would be based on thirty years, and advances would stop at the end of thirty years. The monthly advance would be only incrementally higher than that of a Home Tenure Scheduled Advances plan which would be calculated over thirty-three years, yet continue even if the borrower lives to be one hundred and ten years old.

### Alternate Embodiment

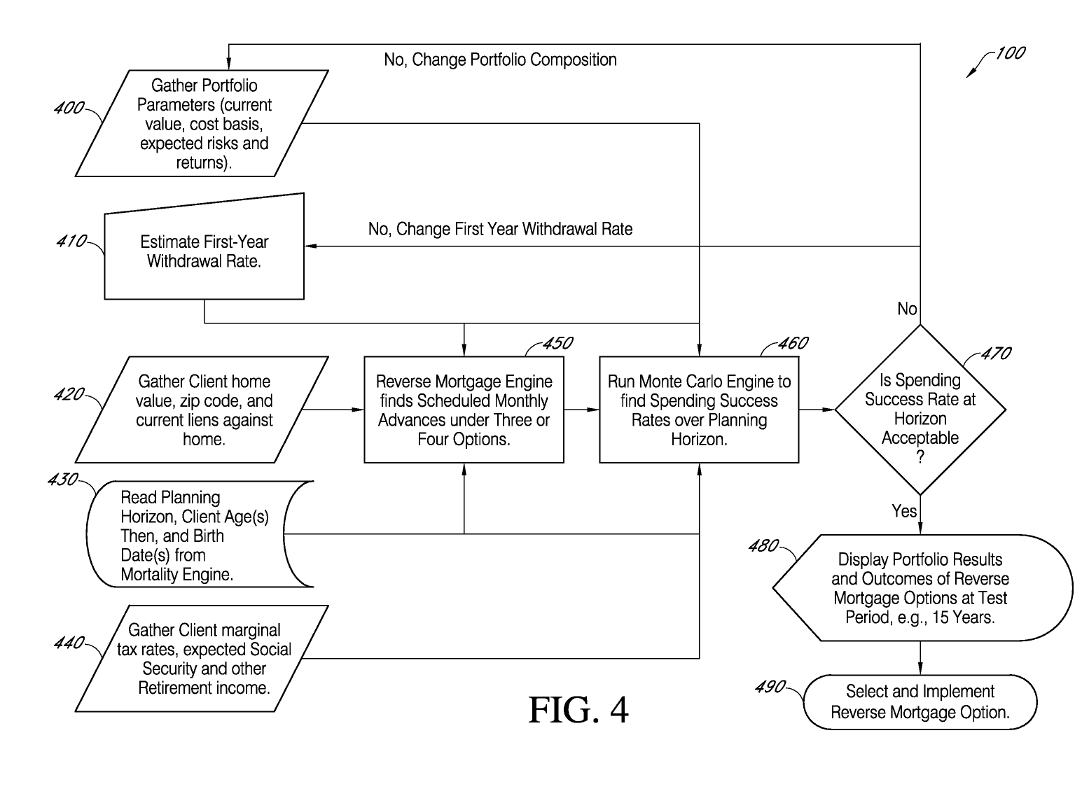

FIG. 4 is a flowchart that illustrates an alternate embodiment of the computer system 100 for determining and implementing a strategy for using a reverse mortgage as a portfolio supplement. As depicted in FIG. 4, at 420 information about a client home value, a zip code, and current liens against the home are gathered and provided at 450 to a Reverse Mortgage Engine. Also provided to the Reverse Mortgage Engine 450 are an estimate of a desired initial spending amount 410 and, from the Mortality Engine, at 430, information about a planning horizon, client age(s) at the planning horizon, and birth date(s).

With the above-described input information, the Reverse Mortgage Engine 450 calculates one or more schedules of monthly advances under various reverse mortgage options. These schedules from the Reverse Mortgage Engine 450, together with portfolio parameters from 400, such as current value, cost basis, expected risks and returns, and information from 440 about client marginal tax rates, expected Social Security and other retirement income, are provided to the Monte Carlo Engine 460, which is run to find spending success rates for various reverse mortgage funding options as well as for a portfolio-only funding option over the planning horizon, and to present these results for display to the client.

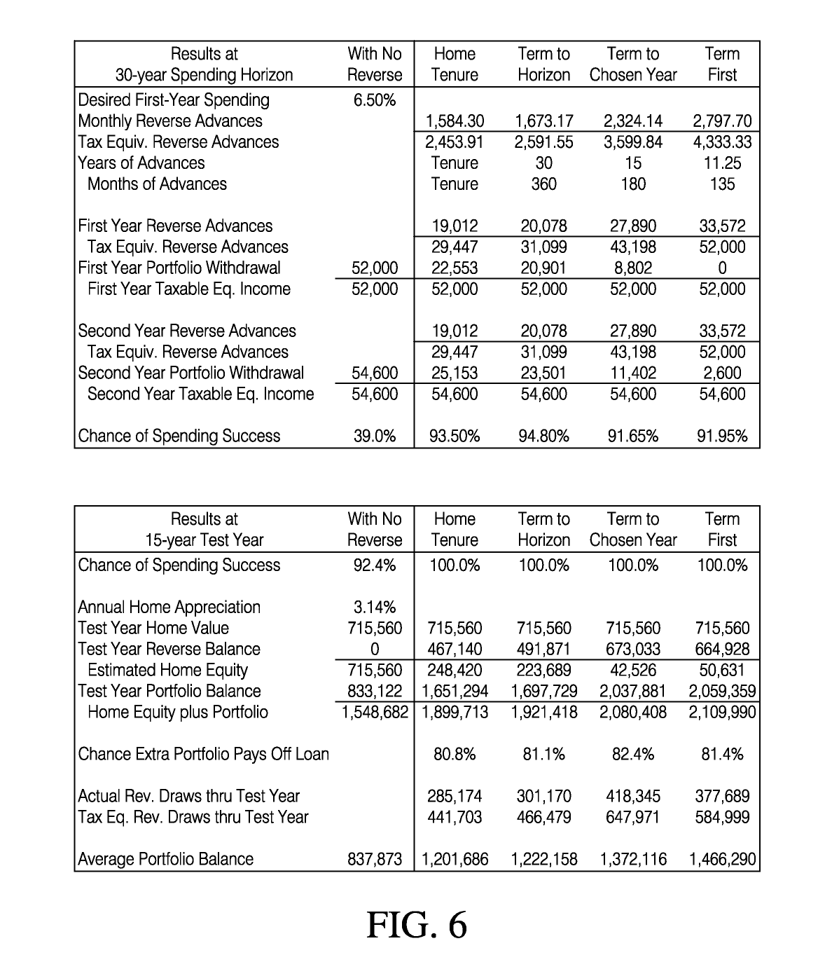

In some embodiments, the Monte Carlo Engine 460 can run several thousand simulations for each funding option in order to generate reliable results for presenting to a retiree seeking advice regarding the choice of a retirement funding strategy. For example, in the embodiment used to generate the results presented in FIGS. 5A, 5B, and 6, the Monte Carlo Engine 460 ran two thousand simulations for each funding option. Running a high number of simulations can provide results that are more reliable and more accurately predictive on average, with less variability between results based on the same input parameters, but in other embodiments, lower numbers of simulations are run, such as one thousand simulations or possibly even hundreds of simulations, in order to more quickly produce results for consideration by a client, such as during a quick meeting with a client.

In 470, the client and/or financial planner determine if the spending success rate of one or more options at the planning horizon is acceptable. In some embodiments, if the spending success rate is acceptable, in 480, the system can display portfolio results and outcomes of the various retirement funding options at a test period (such as at fifteen years) for further comparison and determination of a preferred reverse mortgage option.

Finally, at 490, the financial planner, lender, and/or the client select and implement the selected reverse mortgage option. In some embodiments, the financial planner provides the client with information about preferred, qualified reverse mortgage lenders. The client and/or the financial planner can obtain proposals from one or more of the qualified reverse mortgage lenders and can confirm a preferred reverse mortgage option available from the lender. The client can submit an application, received third-party reverse mortgage counseling (if, as is currently the case, that such counseling is required by law), and can participate in processing and closing the reverse mortgage loan. In some embodiments where the system 100 is used by a qualified reverse mortgage lender, the lender may process the desired reverse mortgage loan for the client.

### Comparative Display of Retirement Funding Strategy Outcomes

### Over a Thirty-Year Horizon

FIGS. 5A and 5B depict one embodiment of sample displays 500, 550 of Monte Carlo simulation results that have been generated and presented for display to one or more users. The data results can provide a side-by-side pictorial comparison of various retirement funding strategies, allowing the client and/or any other viewer to compare, for example, and among other things, (a) the chances of “spending success” for the different plans, (b) the portfolio value at one or more test periods, including at the end of the planning horizon, and (c) the remaining home equity at one or more test periods, including at the end of the planning horizon.

FIG. 5A provides results pertaining to the full planning horizon of 30 years. Thus, they can show a statistical level of confidence for each retirement funding strategy that it can fulfill its assumed promise to provide reliable and regular retirement funding over the entire planning horizon.

As depicted in the upper-left corner of the display 500, some base assumptions 501 about the simulation results can be noted. In this example, the initial portfolio value is $800,000. The desired rate of initial withdrawal is 6.5% of the portfolio value. This rate is significantly higher than conventional wisdom, even amongst financial planners, recognizes as possible, especially with an acceptable level of “spending success” across the planning horizon. The results show surprising and unexpected outcomes made possible by the systems and methods described herein.

Also noteworthy in the base assumptions 501, is the recognition that funds withdrawn from a portfolio are taxable, while funds drawn from a reverse mortgage are not. We use the after-tax amount that is available for spending from the original 6.5% withdrawal to define the annual base rate of funds needed across the retirement horizon. Dividing the annual amount by twelve, we get the monthly base rate, which in this example, is $2,798. Thus, we only need $2,798 in reverse mortgage funds in order to provide the retirees with the monthly spending power that a monthly portfolio withdrawal of $4,333 would provide.

The display 500 presents five columns 502, 510, 520, 530, and 540 of information, each displaying the results for one of five different retirement spending strategies.

The results shown in column 502 pertain to a funding strategy that relies entirely on withdrawing funds from the portfolio, with no supplement of reverse mortgage funds at all.

Following down to the bottom box 505 of column 502, we see that using the portfolio funds alone, to draw the same monthly amount (but increased by 2.5% yearly for inflation), results in a situation where, at the end of the thirty-year spending horizon, there is only a 39.0% chance that any money will be left in the portfolio. That means that in 61.0% of the simulations, desired withdrawals ceased before the end of the thirty-year spending horizon. Unless a client were satisfied with this level of security, and barring any use of reverse mortgage funds, it is likely that the client would choose to make a new plan with a significantly lower monthly spending allotment, or would make some other types of changes.

The results shown in the four remaining columns, 510, 520, 530, and 540, pertain to retirement funding strategies that each rely, at least in part, on funds from different reverse mortgage plans, as labeled in boxes 511, 521, 531, and 541. Each of the four reverse mortgage plans described provides for a regular schedule of fixed-amount advances. In practice, the actual amount or retirement funds disbursed frequently increases 2.5% per year to keep pace with inflation. Since monthly reverse mortgage advances are a fixed dollar amount, all increases for inflation can be taken from the portfolio or from another source.

The next row of boxes 512, 522, 532, 542 provides a brief description of each of the reverse mortgage options being explored in this example. As shown in box 512, the Home Tenure Plan provides $1,584 tax-free per month for as long as the home remains the clients' principal residence. This translates to a tax-equivalent value of $2,454 per month from the reverse mortgage and allows more than half of the original planned portfolio withdrawals, for the early years at least, to remain in the portfolio, where the funds have a chance to grow. As shown in box 515 at the bottom, this Home Tenure Plan comes in with a 93.5% chance of “spending success” over the thirty-year planning horizon.

As shown in box 522, the Term Advances Plan Across Entire 30-year Horizon provides $1,673 tax-free per month for thirty years. This translates to a tax-equivalent value of $2,592 per month from the reverse mortgage and again allows more than half of the original portfolio withdrawals, to remain in the portfolio, where it has a chance to grow. As shown in box 525 at the bottom, this Term Advances Plan (Thirty Years) comes with a 94.8% chance of “spending success” over the 30-year planning horizon.

As shown in box 532, the Term Advances Plan Across a Chosen Horizon (for example, Fifteen Years) provides $2,324 tax-free per month for fifteen years. This translates to a tax-equivalent value of $3,600 per month from the reverse mortgage and again allows more than 85% of the original portfolio withdrawals, for the first year at least, to remain in the portfolio, where it has a chance to grow. As shown in box 535 at the bottom, this Term Advances Plan (15 Years) comes in with a 91.7% chance of “spending success” over the 30-year planning horizon. This is the lowest likelihood of “spending success” of all the reverse mortgage options, but it still strongly out-performs the portfolio-only option.

As shown in box 542, the Term First Plan, as structured in this example, provides the full $2,798 tax-free per month (but not any additional amounts for inflation) for as long as the capacity of the reverse mortgage is not exhausted. This translates to a tax-equivalent value of $4,333 per month from the reverse mortgage and allows all of the original portfolio withdrawal (except for the amounts to make up for inflation) to remain in the portfolio, where they have a chance to grow, at least for 11.25 years, until the Reverse Mortgage capacity is exhausted. As shown in box 545 at the bottom, this Term First Plan comes with a 92.0% chance of “spending success” over the 30-year planning horizon.

### Over the 15-Year Test Period

FIG. 5B provides results pertaining to a test period, which in this example was selected to be fifteen years. While clients frequently do want the peace of mind of the knowing that their assets will last as long as they do, even if they live to be quite old, they also can relate more easily to a future that is only fifteen years away. Providing reassurance that a retirement spending strategy is good for them, not only in the long run, but also in terms of shorter-term stewardship of their assets, can be important to retirees in search of a retirement funding strategy. Furthermore, clients who understand that when using a funding strategy that includes a reverse mortgage, an increase in portfolio value comes at the price of some home equity, will want to know if the bargain has been an overall gain or loss for them.

Looking then at the fifteen-year test period for the same five retirement funding strategies, the Monte Carlo display 550 can provide, for each plan, the expected average portfolio value in fifteen years, the remaining home equity in fifteen years, and the total of home equity and portfolio value in fifteen years. Reading across the lowest full row of boxes 507, 567, 577, 587, 597, the total home equity and portfolio values in fifteen year are: $1,548,682 for the portfolio-only plan, and, for the four reverse mortgage options: values ranging from $1,899,713 to $2,109,990. As shown by the lowest row of boxes 568, the total net worth after fifteen years ranges from $351,031 to $561,308 higher than by using the portfolio-only strategy. These material increases in net worth resulting from a reverse mortgage supplementing portfolio withdrawals are unexpected and beneficial results.

### Alternate Embodiment of Results Presented to User

FIG. 6 depicts an embodiment of a compact, tabular presentation of the Monte Carlo simulation results that may be generated and presented to a user to provide a comparison of various retirement funding strategies. The sample results shown in FIG. 6 are generated based on the same inputs as were used to generate the results shown in FIGS. 5A and 5B. An upper portion of the results shown in FIG. 6 present a comparison of the performance of the same five retirement funding strategies across a thirty-year spending horizon and clearly displays the calculated chance of spending success for each.

A bottom half of the tabular presentation provides a comparison of the performance of the same five retirement funding strategies at the end of fifteen years. As shown near the top of that section, the No-Reverse funding strategy does not even have a 100% chance of spending success at the end of fifteen years, let alone at the end of the full thirty-year planning horizon. Furthermore, as shown at the bottom of that section, the average portfolio balances displayed provide further evidence that retirees looking to preserve, and even to expand their financial assets during their retirement years, have several attractive options to consider that make use of funds from a reverse mortgage to extend and enhance a retirement savings portfolio.

Also shown in the bottom half of FIG. 6 is evidence of a surprising and unexpected outcome: for all four of the reverse mortgage strategies used in the simulations, the extra funds which were allowed to stay in the portfolio thanks to the reverse mortgage funding strategies actually grew to be enough money to completely pay off the reverse mortgage loans. In fact, as shown in the bottom half of FIG. 6, there is over an 80% Chance that the Extra Portfolio amount is sufficient to Pay Off the Loan for any one of the reverse mortgage strategies. This is all the more significant in light of the fact that the sample calculations presented herein were based, at least in part, on financial assumptions that are quite conservative, in keeping with our current financial climate, and that performance could actually be expected to be even better under more positive market conditions.

### Example System Architecture

FIG. 7 is a block diagram that depicts one embodiment of a computer system 700 for determining and implementing a strategy for using a reverse mortgage as a portfolio supplement.

In some embodiments, the systems, computer clients and/or servers described herein take the form of a computing system as shown in FIG. 7. FIG. 7 is a block diagram showing an embodiment in which computing system 700 is in communication with a network 760 and various systems are also in communication with the network 760. The computing system 700 may be used to implement systems and methods described herein. For example, the computing system 700 may be used to accept data from an individual interested in learning about strategies for extending their investment portfolio by combination with a reverse mortgage program. The computing system 700 may be further used to access additional data and to calculate various Monte Carlo or other simulations and to present such simulations for use by the individual. In some embodiments, the system is accessed remotely by the client 764, the system is local to the client 764, and/or a combination of the two. In some embodiments, the client 764 may access a partner service 766, such as a financial planning service or other service provider, which in turn communicates with computing system 700 in order to provide at least some of the inputs used for initiating the simulations and for accessing output of the simulations, such as via a user interface control provided on a user interface generated by the partner service 766 for display to the client 764. In some embodiments, such partner services 766 can provide regular updates for inputs, such as those that fluctuate based on real estate and/or financial market conditions and/or that may be set by a governmental or other institutional body.

The computing system 700 can further include, for example, a personal computer that is IBM, Macintosh, or Linux/Unix compatible. In one embodiment, the computing system 700 comprises a server, a laptop computer, a cell phone, a personal digital assistant, a kiosk, or an audio player, for example. In one embodiment, the exemplary computing system 700 includes a central processing unit (“CPU”) 705, which may include a conventional microprocessor. The computing system 700 further includes a memory 730, such as random access memory (“RAM”) for temporary storage of information and a read only memory (“ROM”) for permanent storage of information, and a mass storage device 720, such as a hard drive, diskette, or optical media storage device. Typically, the modules of the computing system 100 are connected to the computer using a standard based bus system. In different embodiments, the standard based bus system could be Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing system 700 may be combined into fewer components and modules or further separated into additional components and modules.

The computing system 700 is generally controlled and coordinated by operating system software, such as Windows 95, Windows 98, Windows NT, Windows 2000, Windows XP, Windows Vista, Unix, Linux, SunOS, Solaris, or other newer and/or compatible operating systems. In Macintosh systems, the operating system may be any available operating system, such as MAC OS X. In other embodiments, the computing system 700 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 700 includes one or more commonly available input/output (I/O) devices and interfaces 710, such as a keyboard, mouse, touchpad, and printer. In one embodiment, the I/O devices and interfaces 710 include one or more display device, such as a monitor, that allows the visual presentation of data to a user. More particularly, a display device provides for the presentation of GUIs, application software data, and multimedia presentations, for example. The computing system 700 may also include one or more multimedia devices 740, such as speakers, video cards, graphics accelerators, and microphones, for example.

In the embodiment of FIG. 7, the I/O devices and interfaces 710 provide a communication interface to various external devices. In the embodiment of FIG. 7, the computing system 700 is electronically coupled to a network 760, which comprises one or more of a LAN, WAN, the Internet, or cloud computing, for example, via a wired, wireless, or combination of wired and wireless, communication link 715. The network 760 communicates with various computing devices and/or other electronic devices via wired or wireless communication links.

According to FIG. 7, information may be provided to computing system 700 over the network 760 from one or more data sources including, for example, data source(s) 762 that store data about government and/or private reverse mortgage plans and programs, financial data about inflation rates, lending rates, and the like, governmental data about taxation, or any other relevant data. In addition to the devices that are illustrated in FIG. 7, the network 760 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database. In addition to supplying data, a client 764 may request information from the computing system 700.

In the embodiment of FIG. 7, the computing system 700 also includes a data sharing module 750, which may be executed by the CPU 705. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment of FIG. 7, the computing system 700 also includes a computational module 735, which may be executed by the CPU 705 in order to implement functionality described elsewhere herein. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 7, the computing system 700 is configured to execute the computational module 735 in order to implement functionality described elsewhere herein. For example, the computational module 735 module may perform methods described with reference to some or all of any of various modules described above with reference to the Reverse Mortgage Engine, the Mortality Engine, The Portfolio Initialization Engine, and/or the Monte Carlo Engine, depending on the embodiment.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 410, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, one or more computing systems, data stores and/or modules described herein may be implemented using one or more open source projects or other existing platforms. For example, one or more computing systems, data stores and/or modules described herein may be implemented in part by leveraging technology associated with one or more of the following: Drools, Hibernate, JBoss, Kettle, Spring Framework, NoSQL (such as the database software implemented by MongoDB) and/or DB2 database software.

### Other Embodiments

Although the foregoing systems and methods have been described in terms of certain embodiments, other embodiments will be apparent to those of ordinary skill in the art from the disclosure herein. Additionally, other combinations, omissions, substitutions and modifications will be apparent to the skilled artisan in view of the disclosure herein. While some embodiments of the inventions have been described, these embodiments have been presented by way of example only, and are not intended to limit the scope of the inventions. Indeed, the novel methods and systems described herein may be embodied in a variety of other forms without departing from the spirit thereof. Further, the disclosure herein of any particular feature, aspect, method, property, characteristic, quality, attribute, element, or the like in connection with an embodiment can be used in all other embodiments set forth herein.

All of the processes described herein may be embodied in, and fully automated via, software code modules executed by one or more general-purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

### Additional Terminology

A number of computing systems have been described throughout this disclosure. The descriptions of these systems are not intended to limit the teachings or applicability of this disclosure. For example, the user systems described herein can generally include any computing device(s), such as desktops, laptops, video game platforms, television set-top boxes, televisions (e.g., internet TVs), computerized appliances, and wireless mobile devices (e.g. smart phones, PDAs, tablets, or the like), to name a few. Further, it is possible for the user systems described herein to be different types of devices, to include different applications, or to otherwise be configured differently. In addition, the user systems described herein can include any type of operating system (“OS”). For example, the mobile computing systems described herein can implement an Android™ OS, a Windows® OS, a Mac® OS, a Linux or Unix-based OS, or the like.

Further, the processing of the various components of the illustrated systems can be distributed across multiple machines, networks, and other computing resources. In addition, two or more components of a system can be combined into fewer components. For example, the various systems illustrated as part of the data center resource allocation system 330 can be distributed across multiple computing systems, or combined into a single computing system. Further, various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Depending on the embodiment, certain acts, events, or functions of any of the algorithms, methods, or processes described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each process described may be implemented by one or more computing devices, such as one or more physical servers programmed with associated server code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to mean “one or more” or “at least one” unless specified otherwise.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A financial computing tool, comprising:
a microprocessor coupled with memory, an input, and an output;
wherein said input receives information about a client, said client being an individual or an individual and the individual's spouse or other domestic partner, and wherein said information about said client comprises:
information about a home owned by said client, including information about said client's equity in said home;
information about an investment portfolio owned by said client;
information about the age(s) of said client; and
information about an amount of funds desired by said client to be available to said client for spending during a spending horizon, wherein said spending horizon is a number of future years;
wherein said memory stores information, comprising:
information about reverse mortgage programs;
statistical information, including a standard mean and a standard deviance, about estimated portfolio growth returns;
statistical information, including a standard mean and a standard deviance, about estimated residential property value growth;
statistical information about mortality rates; and
information about government tax rates;
wherein said microprocessor calculates, based at least in part on information received from said input and based at least in part on information stored in said memory, two or more estimated schedules of future values for said client's investment portfolio and said client's home equity;
wherein one of said estimated schedules provides predicted future portfolio and home equity values that are based, at least in part, on an assumption that said client withdraws from said portfolio on a regular basis said desired amount of funds to be available for spending during said spending horizon; and
wherein one or more of said estimated schedules provides predicted future portfolio and home equity values that are based, at least in part, on an assumption that said client receives scheduled advances from a reverse mortgage plan, said scheduled advances providing all or part of said desired amount of funds to be available to said client for spending during said spending horizon; and
wherein said output presents an indication of said two or more estimated schedules of future values for said client's investment portfolio and said client's home equity.
